(19) United States
(12) Patent Application Publication
(10) Pub. No.: US 2003/0127543 A1
(43) Pub. Date: Jul. 10, 2003

(54) Fuel injector

(76) Inventors: Franz Rieger, Schwieberdingen (DE); Thomas Ludwig, Huenxe (DE); Hans Schlembach, Muehlacker (DE); Gottlob Haag, Markgroeningen (DE); Ulrich Brenner, Moeglingen (DE); Michael Huebel, Gerlingen (DE); Juergen Stein, Illingen (DE); Udo Sieber, Bietigheim (DE)

Correspondence Address: KENYON & KENYON, ONE BROADWAY, NEW YORK, NY, 10004, US

(21) Appl. No.: 10/169,962

(22) PCT Filed: Nov. 12, 2001
(86) PCT No.: PCT/DE01/04208

(30) Foreign Application Priority Data
Nov. 11, 2000 (DE) 100 56 039.3

(51) Int. Cl. B05B 12/10

(52) U.S. Cl. 239/584; 239/596; 239/494; 239/497; 239/552; 239/75; 239/397.5

(57) ABSTRACT

A fuel injector, in particular an injector for fuel injection systems in internal combustion engines, includes a valve needle (6) having a valve-closure member (7) which cooperates with a valve-seat surface (8) situated in valve-seat member (5) to form a sealing seat (9) and which has several injection orifices (4, 12) which are situated downstream from the sealing seat (9), and are sealed by sealing seat (9) against a fuel supply. A disk element (10) is arranged downstream from the sealing seat (9), the disk element (10) having at least one valve section (11), which changes its shape when the temperature changes. Valve section (11) is connected to a heating element (13) and is possibly covering an injection orifice (12).

### Background Information

The present invention relates to a fuel injector according to the preamble of the main claim.

A fuel injector which is able to control several injection orifices separately is known from German Patent Application 32 28 079 A1. The fuel injector has two valve needles which are each acted upon with a prestressing force by a spring against a sealing seat. If one valve needle is raised from its sealing seat by a certain prelift, it strikes a stop of the other valve needle and picks up this valve needle as it continues its lift. The two sealing seats of the two valve needles seal different injection orifices which may be oriented at different angles. However, the design has multiple parts and it is necessary to precisely manufacture two sealing seats, which entails high costs. It is further disadvantageous that merely two groups of injection orifices may be controlled separately and a further selection of injection orifices to be opened is not possible.

A fuel injector for internal combustion engines having a valve needle and an auxiliary needle situated in a bore of the valve needle is known from German Patent Application 30 48 304 A1. At its combustion chamber side section, designed as a valve-closure member, the valve needle, together with a valve-seat surface, forms a sealing seat, which separates the injection orifices from a fuel supply. The auxiliary needle, guided in the valve needle, also has a valve-closure member, which cooperates with a second valve-seat surface of the fuel injector. A spring, situated in the valve needle, pulls the auxiliary needle against the valve needle, toward which, together with a valve-seat surface, it also forms a sealing seat in the valve needle. When the hydraulically operated fuel injector begins to open due to an increase in pressure in the fuel line, the auxiliary needle is pressed from its sealing seat in the valve needle against the sealing seat in the valve body, sealing a group of injection orifices, while another group of injection orifices is opened. If the pressure further increases, the valve needle is raised from its sealing seat, and after a certain lift picks up the auxiliary needle, which strikes a stop of the valve needle. All injection orifices are then opened. It is a disadvantage that a total of three precisely manufactured sealing seats are necessary. Also with this fuel injector according to the related art, merely two groups of injection orifices may be controlled separately.

A fuel injector having two valve needles, making it possible to open injection orifices in two groups, is also known from German Patent 31 20 044 C2. Here one valve needle is guided inside the other valve needle, which is designed as a hollow needle. This valve needle, designed as a hollow needle, has injection orifices at its end on the combustion chamber side. It is disadvantageous that the manufacture of the hollow needle is very complex, because the hollow needle also has injection orifices, and therefore one component combines two functions, which require a precise manufacture of the component.

### ADVANTAGES OF THE INVENTION

The fuel injector according to the present invention having the characterizing features of the main claim has the advantage over the related art that it offers a cost-effective, and with regard to manufacturing engineering an easily implementable, method of controlling the injection orifices to be opened, since not only do the injection orifices not require another precisely manufactured sealing seat in order to be opened separately, but also the injection orifices, assigned to a valve section, may be opened independently if the respective heating element of the valve section is controlled separately from the valve-closure member. At the maximum all injection orifices may thus be selected separately if all injection orifices are assigned a respective valve section and the respective heating elements are controllable separately from one another. As soon as the valve-closure member opens, only the injection orifices not covered by their valve sections inject fuel.

In particular, the distribution of fuel in the jet pattern of the fuel injector may be advantageously influenced by the selection of the injection orifices.

Advantageous refinements of and improvements on the fuel injector described in the main claim are made possible by measures described in the subclaims.

At least the valve section of the disk element may advantageously be made of bimetal and the lamination of the bimetal may be designed so that the valve section clears the injection orifices when heated.

Alternatively, the valve section of the disk element may be made of bimetal and the lamination of the bimetal may be designed so that the valve sections of the disk element cover the injection orifices when heated.

In an advantageous embodiment at least the valve section of the disk element is made of a shape memory alloy, in particular a shape memory alloy having a two-way effect.

The heating elements may advantageously include resistance wires situated on the valve sections.

At the maximum, all valve sections of the disk element may be separately selected and opened, if a separate control line is provided for each of the resistance wires.

The valve-seat member or the injection orifice plate advantageously has a second hole circle of injection orifices, situated radially outside of the first hole circle, and correspondingly shaped valve sections of the disk element are assigned to the injection orifices of the second hole circle.

Advantageously, the injection orifices may have different injection angles, orifice diameters, and axial lengths.

### DRAWING

An exemplary embodiment of a fuel injector according to the present invention is illustrated in simplified form in the drawing and explained in greater detail in the following description.

FIG. 1 shows a sectional view through a detail of an exemplary embodiment of a fuel injector according to the present invention having a closed valve needle and covered injection orifices;

FIG. 2 shows the same detail as in FIG. 1 having cleared injection orifices;

FIG. 3 shows the plane of section III-III in FIG. 1 in top view, and FIG. 4 shows sectional detail IV from FIG. 2.

### DESCRIPTION OF THE EXEMPLARY EMBODIMENTS

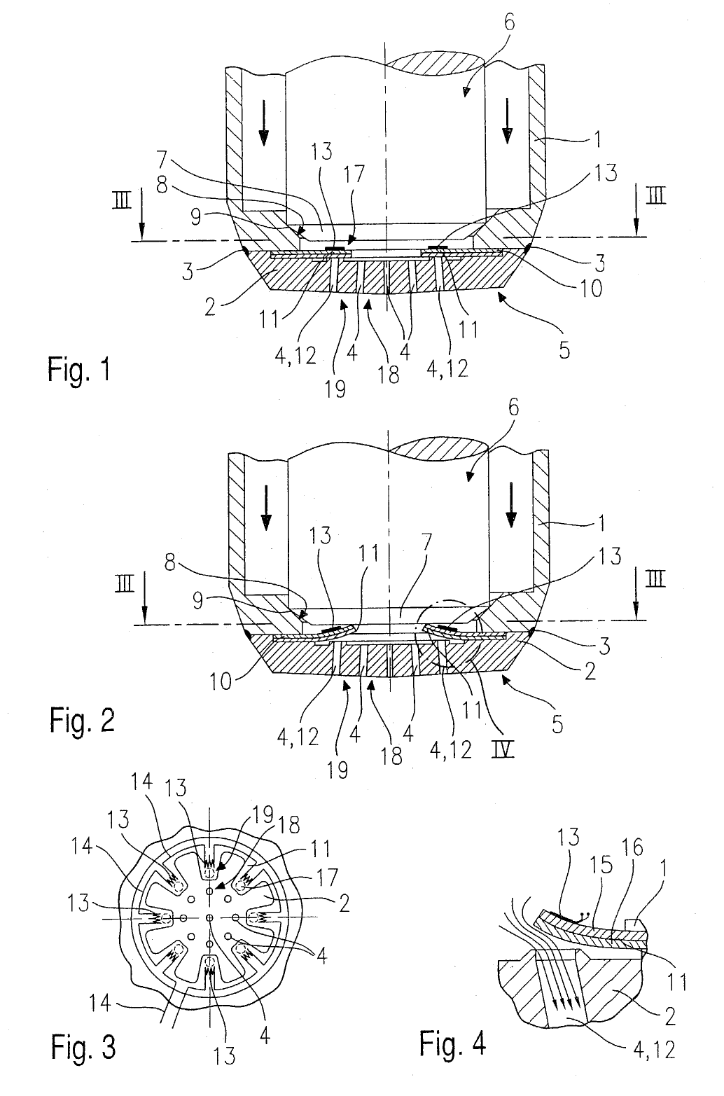

FIG. 1 shows in a sectional view a detail of the section of a fuel injector according to the present invention, facing the combustion chamber of an internal combustion engine, not shown here.

A valve body 1 is connected via weld 3 to injection orifice plate 2, which has injection orifices 4, together forming valve-seat member 5. A valve needle 6 has a valve-closure member 7 at its end facing the combustion chamber, not shown here. Valve-closure member 7 cooperates with valve-seat surface 8, shaped as a frustum of a cone, for example, situated in valve body 1, to form sealing seat 9. A disk element 10 is arranged on injection orifice plate 2 and is held on injection orifice plate 2 by valve body 1. Disk element 10 has radially inwardly protruding valve sections 11, which arranged in hole circle 19 cover outer injection orifices 12 at normal operating temperature. Heating elements 13 are arranged on valve sections 11. Valve sections 11 are designed as tongues 17 pointing radially to the center. In the exemplary embodiment, disk element 10 is made of bimetal, whose lamination is formed so that valve sections 11 cover outer injection orifices 12 at low temperature, when heating elements 13 do not additionally heat valve sections 11.

FIG. 1 shows the fuel injector in its closed state. Heating elements 13 are not controlled, and valve sections 11 of disk element 10 have the normal operating temperature or lower. The design of the bimetal causes valve sections 11 to be pressed onto the injection orifices 12 arranged in a circle and closes them. If valve needle 6 is now raised from sealing seat 9, fuel may then flow out of uncovered injection orifices 4, e.g., an inner hole circle 18. Injection orifices 4 alone determine the jet pattern of the fuel.

FIG. 2 illustrates the same exemplary embodiment of the present invention. The drawing shows the same detail; therefore, the same components are identified by the same reference numbers. However, the fuel injector is illustrated having valve sections 11 of disk element 10 activated by heating.

Valve body 1 is connected to injection orifice plate 2 containing injection orifices 4 via weld 3, and forms valve-seat member 5. Valve needle 6 together with valve-closure member 7 is designed in one piece. Valve-closure member 7 cooperates with valve-seat surface 8, formed in valve body 1, to form sealing seat 9. Disk element 10 is arranged on injection orifice plate 2 and is held on injection orifice plate 2 by valve body 1. Valve sections 11 and respective heating elements 13 are arranged over outer injection orifices 12 which form second hole circle 19.

The fuel injector is illustrated in its closed state. Heating elements 13 additionally heat valve sections 11. Thus, valve sections 11 bend away from respective injection orifices 12 and clear them. If valve needle 6 is now raised from sealing seat 9, the fuel may flow out of all uncovered injection orifices 4, 12. Two valve sections 11, clearing their respective outer injection orifices 12, are illustrated. Thus, the number of separately clearable injection orifices depends solely on the possibility of controlling heating elements 13 separately. The number of injection orifices 12 to be cleared by controlling respective heating elements 13 is advantageously-selected during the period when the fuel injector is closed. The fuel injector is opened by valve needle 6 as accurately and rapidly as a fuel injector described in the related art.

FIG. 3 shows the plane of section III-III of FIG. 1. Injection orifices 4 are arranged in injection orifice plate 2. Valve sections 11 cover outer injection orifices 12. Heating elements 13 are arranged on valve sections 11. Heating elements 13 are designed as resistance wires, for example, being connected via a common lead wire 14. For outer hole circle 19, heating elements 13 may be actuated together in this embodiment of the present invention.

FIG. 4 shows the detail IV of FIG. 2. Injection orifice 4, being an outer injection orifice 12, is arranged in injection orifice plate 2. Valve section 11 is heated by heating element 13 and therefore is raised from outer injection orifice 12. The edge of valve body 1 securing disk element 10 and valve section 11 is still discernible. Valve section 11, made of bimetal, has an upper layer 15 having less thermal expansion and a lower layer 16 having greater thermal expansion. The direction of flow of the fuel, when the fuel injector is opened, is marked by arrows.

Alternatively, valve section 11 may also be made of a shape form alloy, one, in particular, having a two-way behavior. Here, the deformation is a function of the temperature increase and is reversible when the temperature decreases.

The angle of a fuel injection cone may overall be influenced by a different configuration of the angles at which outer injection orifices 12 and remaining injection orifices 4 are placed. The embodiment of a fuel injector according to the present invention advantageously makes a high switching rate possible. The embodiment according to the present invention is also implementable in a cost-effective manner.

What is claimed is:

1. A fuel injector, in particular an injector for fuel injection systems of internal combustion engines, having a valve-closure member (7), which cooperates with a valve-seat surface (8) in a valve-seat member (5) to form a sealing seat (9), several injection orifices (4, 12) being arranged downstream from the sealing seat (9), which are sealed from a fuel supply by the sealing seat (9),
wherein a disk element (10) is situated downstream from the sealing seat (9), the disk element (10) having at least one valve section (11) which changes its shape when the temperature changes, the valve section (11) being connected to a heating element (13), and the valve section (11) being able to cover an injection-orifice (12).

2. The fuel injector according to claim 1,
wherein at least the valve section (11) of the disk element (10) is made of a bimetal.

3. The fuel injector according to claim 2,
wherein the lamination of the bimetal causes the valve sections (11) of the disk element (10) to unblock the injection orifices (12) when heated.

4. The fuel injector according to claim 2,
wherein the lamination of the bimetal causes the valve sections (11) of the disk element (10) to cover the injection orifices (12) when heated.

5. The fuel injector according to claim 1,
wherein at least the valve section (11) of the disk element (10) is made of a shape memory alloy.

6. The fuel injector according to claim 5,
wherein the shape memory alloy has a two-way effect.

7. The fuel injector according to one of claims 1 through 6,
wherein the heating elements (13) include electric heating wires being arranged on the valve sections (11).

8. The fuel injector according to one of claims 1 through 7,
wherein the valve sections (11) are designed as radially inwardly oriented tongues (17) of the disk element (10) and a portion of the injection orifices (12) in an outer hole circle (19) is assigned to the valve sections (11) of the disk element (10).

9. The fuel injector according to claim 8,
wherein the injection orifices (4, 12) are arranged in an inner hole circle (18) and an outer hole circle (19) on valve seat member (5) or on an injection orifice plate (2).

10. The fuel injector according to one of claims 1 through 9,
wherein the injection orifices (4, 12) have different injection angles.

11. The fuel injector according to one of claims 1 through 10,
wherein the injection orifices (4, 12) have different opening diameters and/or different axial lengths.

12. The fuel injector according to one of claims 1 through 11,
wherein the valve-closure member (7) is actuatable via a valve needle (6) using an electromagnetic or a piezoelectric actuator.

13. The fuel injector according to one of claims 1 through 12,
wherein the injection orifices (4, 12) are formed in an injection orifice plate (2), which is firmly connected to a valve body (1) having the sealing seat (9).
